(19) United States
(12) Patent Application Publication
(10) Pub. No.: US 2014/0320348 A1
(43) Pub. Date: Oct. 30, 2014

(54) POSITION ESTIMATING DEVICE, POSITION ESTIMATING METHOD, AND WIRELESS COMMUNICATION SYSTEM

(71) Applicant: KABUSHIKI KAISHA TOSHIBA, Minato-ku (JP)

(72) Inventors: Cam LY NGUYEN, Yokohama-Shi (JP); Ren Sakata, Yokohama-Shi (JP); Tatsuma Hirano, Tokyo (JP); Toshiyuki Nakanishi, Yokohama-Shi (JP)

(73) Assignee: KABUSHIKI KAISHA TOSHIBA, Minato-ku (JP)

(21) Appl. No.: 14/197,906

(22) Filed: Mar. 5, 2014

(30) Foreign Application Priority Data
Apr. 24, 2013 (JP) 2013-091779

(51) Int. Cl. G01S 5/02

(52) U.S. Cl. CPC G01S 5/0289
USPC 342/458

(57) ABSTRACT

According to this embodiment, a position estimating device, that estimates a position of a target wireless device, includes a storage that stores positions of a plurality of reference wireless devices, a receiver which is notified of a received signal strength indicator value in signal transmission and reception between the target wireless device and each reference wireless device, a calculator that calculates a standard deviation for a probability distribution of a distance between the target wireless device and each reference wireless device, using the received signal strength indicator value, a first estimator that calculates an estimated distance between the target wireless device and each reference wireless device, using the received signal strength indicator value, and a second estimator that calculates the position of the target wireless device, using the standard deviation, the estimated distance, and the positions of the plurality of reference wireless devices.

### CROSS-REFERENCE TO RELATED APPLICATIONS

This application is based upon and claims the benefit of priority from Japanese Patent Application No. 2013-091779, filed Apr. 24, 2013; the entire contents of which are incorporated herein by reference.

### FIELD

Embodiments of the present invention relate to a position estimating device, a position estimating method, and a wireless communication system.

### BACKGROUND

Conventionally, a signal transmitted from a target wireless device at an unknown position is received by a reference wireless device at a known position, and a received signal strength indicator (RSSI) value is obtained to estimate the position of the target wireless device. In order to estimate the position of the target wireless device, the relationship between the distance between wireless devices and RSSI value is required to be modeled, and the distance between the wireless devices is required to be calculated from the measured RSSI value. However, wireless communication is variously affected. Accordingly, even if the distance is the same, there is a possibility that RSSI value is different according to time and environment. It is thus difficult to estimate a correct position from RSSI value, causing a problem in that the estimation error of the position of the target wireless device is large.

### BRIEF DESCRIPTION OF THE DRAWINGS

FIG. 1 is a schematic configuration diagram of a wireless communication system according to this embodiment;

FIG. 2 is a schematic configuration diagram of a target wireless device according to this embodiment;

FIG. 3 is a schematic configuration diagram of a reference wireless device according to this embodiment;

FIG. 4 is a schematic configuration diagram of a position estimating device according to this embodiment;

FIG. 5 is a flowchart illustrating a position estimating method according to this embodiment;

FIG. 6 is schematic configuration diagram of a position estimating device according to a modification; and

FIG. 7 is a schematic configuration diagram of a wireless communication system according to a modification.

### DETAILED DESCRIPTION

According to this embodiment, a position estimating device, that estimates a position of a target wireless device, comprises a storage that stores positions of a plurality of reference wireless devices. The position estimating device comprises a receiver which receives a received signal strength indicator value in signal transmission and reception between the target wireless device and each reference wireless device. The position estimating device comprises a calculator that calculates a standard deviation for a probability distribution of distances between the target wireless device and each reference wireless device, using the received signal strength indicator value, a first estimator that calculates an estimated distance between the target wireless device and each reference wireless device, using the received signal strength indicator value. The position estimating device comprises a second estimator that calculates the position of the target wireless device, using the standard deviation, the estimated distance, and the positions of the plurality of reference wireless devices.

Embodiments of the present invention are hereinafter described with reference to the drawings.

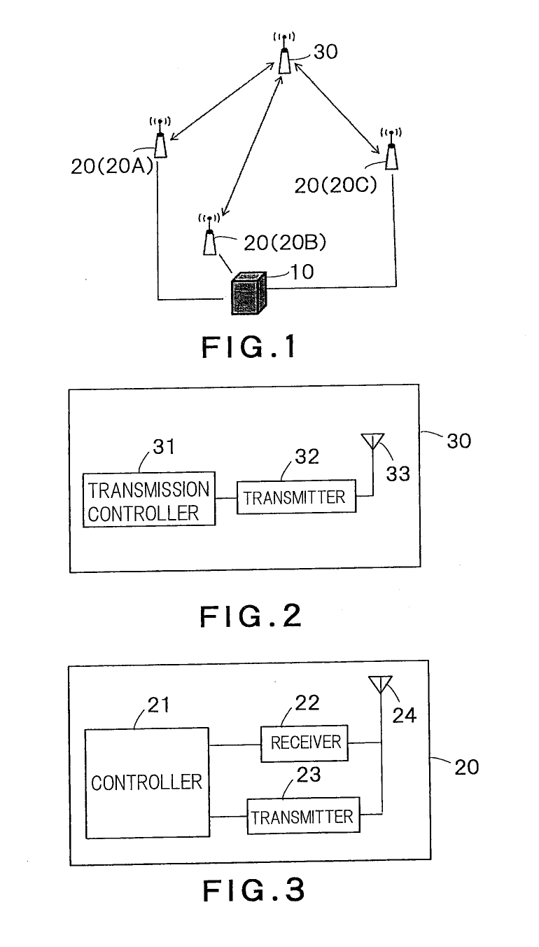

FIG. 1 is a schematic configuration diagram of a wireless communication system according to this embodiment. As shown in FIG. 1, the wireless communication system includes a position estimating device 10, a plurality of reference wireless devices 20, and a target wireless device 30. FIG. 1 shows an example where reference wireless devices 20A to 20C are arranged as the reference wireless devices 20.

The reference wireless devices 20 are wireless devices at preliminarily known (determined) positions. The position estimating device 10 stores position information indicating the positions of the reference wireless devices 20. The position information of the reference wireless devices 20 may be initially registered in the position estimating device 10. Alternatively, the reference wireless devices 20 may notify the position estimating device 10 of the position information of the devices 20 in response to a request by the position estimating device 10.

The target wireless device 30 is a wireless device at a position that is not grasped by the position estimating device 10 and the reference wireless devices 20. In this embodiment, the position estimating device 10 estimates the position of the target wireless device 30.

FIG. 2 is a schematic configuration diagram of the target wireless device 30. As shown in FIG. 2, the target wireless device 30 includes a transmission controller 31, a transmitter 32 and an antenna 33, and serves as a transmitting device. A plurality of antennas 33 may be provided.

The transmission controller 31 generates a transmission signal, and controls the transmitter 32 to transmit the transmission signal at a prescribed period. The transmission signal includes, for instance, individual identifying information of the target wireless device 30. The transmitter 32 transmits the transmission signal via the antenna 33.

FIG. 3 shows a schematic configuration of the reference wireless device 20. As shown in FIG. 3, the reference wireless device 20 includes a controller 21, a receiver 22, a transmitter 23 and an antenna 24, and serves as a transmitting and receiving device. A plurality of antennas 24 may be provided.

The receiver 22 receives the signal transmitted from the target wireless device 30 via the antenna 24, and measures a received signal strength indicator (hereinafter, RSSI) value. The controller 21 controls the transmitter 23 to notify the position estimating device 10 of the RSSI value measured by the receiver 22, the individual identifying information of the target wireless device 30, the individual identifying information of this device 20 and the like. The transmitter 23 transmits the RSSI value, the individual identifying information of the target wireless device 30, and the individual identifying information of this device 20, to the position estimating device 10 via the antenna 24.

In FIG. 3, the example where the reference wireless devices 20 are wirelessly connected to the position estimating device 10 is described. Alternatively, the reference wireless device 20 may be connected to the position estimating device 10 in a wired manner through a LAN cable and the like.

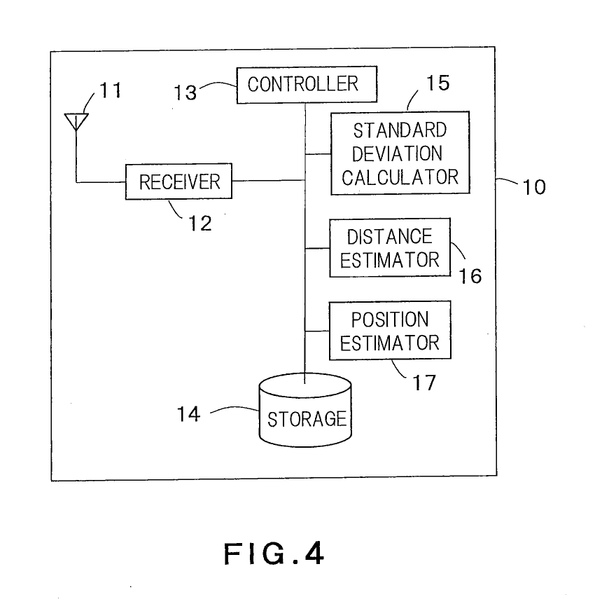

FIG. 4 shows a schematic configuration of the position estimating device 10. The position estimating device 10 includes an antenna 11, a receiver 12, a controller 13, a storage 14, a standard deviation calculator 15, a distance estimator 16 and a position estimator 17. For example, the position estimating device 10 includes at least one CPU(Central Processing Unit), a ROM(Read Only Memory) and a RAM(Random Access Memory). The CPU reads program stored in the ROM or the storage 14, writes it in the RAM and executes it. In this way, the CPU functions as the controller 13, the standard deviation calculator 15, the distance estimator 16 and the position estimator 17.

The receiver 12 receives the measured RSSI value, the individual identifying information of the target wireless device 30 and the individual identifying information of the reference wireless device 20, from the reference wireless device 20 via the antenna 11. For instance, if the signal received by the receiver 12 includes the measured RSSI value, the individual identifying information of the target wireless device 30 and the individual identifying information of the reference wireless device 20A, it can be identified that the measured RSSI value is that of a signal received by the reference wireless device 20A from the target wireless device 30.

When the position estimating device 10 receives, from the plurality of reference wireless devices 20, the measured RSSI values of the transmission signal from the target wireless device 30, this device 10 estimates the position of the target wireless device 30 according to an after-mentioned method.

The controller 13 controls each element of the position estimating device 10. If the receiver 12 receives the position information from the reference wireless device 20, the controller 13 writes the position information in the storage 14. The storage 14 is, for example, a storage device such as a hard disk or a flash memory, and stores various programs and data.

For estimation of distance “d” between the reference wireless device 20 and the target wireless device 30 from the measured RSSI value in the reference wireless device 20, it can be assumed that the probability distribution of the distance “d” conforms to a normal distribution (Gaussian distribution).

For instance, variation in RSSI value can be reduced by averaging temporal variation, variation in frequency, or variation in RSSI value due to movement. The reduction can improve an accuracy of estimating the position of the target wireless device 30. Accordingly, it can be assumed that the probability distribution of the distance “d” between the wireless devices in the case of being provided with the RSSI value conforms to a normal distribution, as described above.

When the reference wireless device 20 measures the RSSI value, the probability distribution of the distance “d” between the reference wireless device 20 and the target wireless device 30 is represented by a probability density function of the following Expression 1.

$$P ( d \vert RSSI ) = \frac{1}{σ ( RSSI ) \sqrt{2 π}} exp ( - \frac{{( d - {d}_{estimate} )}^{2}}{2 {\{ ( σ ( RSSI ) ) \}}^{2}} ) \qquad [ Expression 1 ]$$

where “dₑₛₜᵢₘₐₜₑ” is an estimated distance between the reference wireless device 20 and the target wireless device 30. That is, when the RSSI value is measured, the probability that the distance between the wireless devices is “dₑₛₜᵢₘₐₜₑ” is the highest. “σ(RSSI)” is the standard deviation of the distance for the measured RSSI value. In this embodiment, the standard deviation “σ(RSSI)” of the distance for the probability distribution of the distance “d” is a variable changing according to the measured RSSI value, and is not a constant. The standard deviation calculator 15 of the position estimating device 10 calculates the standard deviation “σ(RSSI)” of the distance according to the probability distribution in Expression 1, for each of the reference wireless devices 20, on the basis of the measured RSSI value notified from the reference wireless device 20. A method of calculating the standard deviation of the distance will be described later.

The distance estimator 16 calculates the estimated distance “dₑₛₜᵢₘₐₜₑ” in Expression 1 for each of the reference wireless devices 20. A method of calculating the estimated distance “dₑₛₜᵢₘₐₜₑ” will be described later.

The position estimator 17 calculates the position of the target wireless device 30 on the basis of the standard deviations of the distances calculated by the standard deviation calculator 15, the estimated distances “dₑₛₜᵢₘₐₜₑ” calculated by the distance estimator 16, and the known positions of the reference wireless devices 20. A method of calculating the position of the target wireless device 30 by the position estimator 17 will be described later.

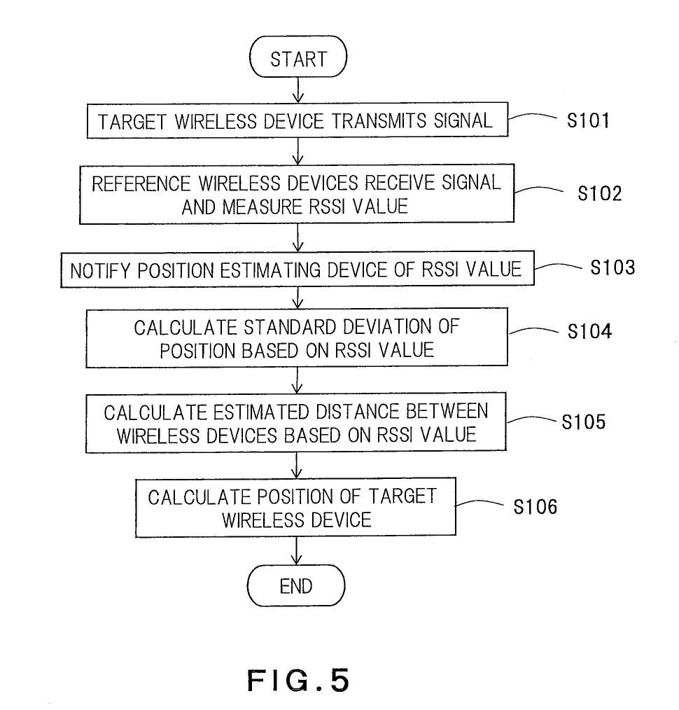

Next, the position estimating method according to this embodiment is described with reference to a flowchart shown in FIG. 5

(Step S101) The target wireless device 30 transmits a signal.

(Step S102) The plurality of reference wireless devices 20 receive the signal transmitted from the target wireless device 30, and measure the RSSI value.

(Step S103) The plurality of reference wireless devices 20 notify the position estimating device 10 of the RSSI value measured in step S102.

(Step S104) The standard deviation calculator 15 of the position estimating device 10 calculates the standard deviation “σ(RSSI)” of the distance according to the probability distribution in Expression 1 for each of the reference wireless devices 20 on the basis of the RSSI values notified from the respective reference wireless devices 20.

The RSSI value and the distance “d” between the wireless devices can be represented by the following Expression 2 representing a path loss. In Expression 2, “α” is an attenuationconstant, and “β” is the average of RSSI values for a distance “d” of one meter.

RSSI=−10α log₁₀ d+β [Expression 2]

The following method is an example of obtaining “α” and “β”. In various environments, such as indoor and outdoor environments, wireless devices are arranged at two sites, and signals are transmitted and received to measure RSSI values. The RSSI value is measured “m” (“m” is a positive integer) times while changing the positions of the wireless devices, thereby obtaining combined data (dₖ, RSSIₖ) of the distance “dₖ” between wireless devices and the actually measured “RSSIₖ”. Here, “k” is an integer ranging from 1 to “m”. The “dₖ” and “RSSIₖ” are fitted to Expression 2 to calculate parameters “α” and “β”.

However, even if the distance “d” is the same, the RSSI value may vary owing to factors, such as multi-path and shadowing. In other words, even if the value of the RSSI is the same, the distance “d” may vary. In this embodiment, it is assumed that the standard deviation for the probability distribution of the distance “d” is different according to the value of RSSI, and the standard deviation calculator 15 calculates the standard deviation “σ(RSSI)” of the distance.

For instance, two wireless devices are preliminarily arranged in various environments, such as indoor and outdoor environments, at various positions, and a signal is transmitted and received to actually measure RSSI value. The measurements of RSSI value are made “m” (“m” is a positive integer) times while changing the positions of the wireless devices, thereby obtaining combined data (dₖ, RSSIₖ) of the distance “dₖ” between wireless devices and the actually measured “RSSIₖ”. Here, “k” is an integer ranging from 1 to “m”. The obtained data is sliced into groups according to the value of RSSI, and the variance of the distance in each slice is obtained according to the following Expression 3.

$$σ ( {RSSI}_{rep , j} ) = \sqrt{\frac{1}{{N}_{j}} {\sum }_{k ∈ Φ ( {RSSI}_{rep , j} )}^{ } {( {d}_{k} - \overline{d} )}^{2}} \qquad [ Expression 3 ]$$

where “RSSI_{rep,j}” is a representative RSSI value of the j-th RSSI slice. A set of indices of data included in the slice can be defined according to the following Expression 4 where the slice width is defined as “Δ”.

Φ(RSSI_{rep,j})={k|RSSI_{rep,j}−Δ/2≦RSSIₖ<RSSI_{rep,j}+Δ/2} [Expression 4]

The number of indices included in “Φ(RSSI_{rep,j})” is represented by the following Expression 5.

Nⱼ=|Φ(RSSI_{rep,j})| [Expression 5]

The average of the distance is represented by the following Expression 6.

$$\overline{d} = \frac{1}{{N}_{j}} {\sum }_{k ∈ Φ ( {RSSI}_{rep , j} )}^{ } {d}_{k} \qquad [ Expression 6 ]$$

The standard deviation “σ(RSSI_{rep,j})” and “RSSI_{rep,j}” that are obtained using Expressions 3 to 6 are plotted on coordinates, and an approximated curve (function) is derived. The thus preliminarily derived approximated curve is stored in, for instance, the storage 14.

The standard deviation calculator 15 for the distance inputs the RSSI value notified from the reference wireless device 20, into the approximated curve to calculate the standard deviation of the distance. For instance, the standard deviation calculator 15 inputs the RSSI values notified from the reference wireless devices 20A to 20C, into the approximated curve, and calculates the standard deviation of the corresponding distance for each of the reference wireless devices 20A to 20C.

(Step S105) The distance estimator 16 calculates the estimated distance “dₑₛₜᵢₘₐₜₑ” between the reference wireless device 20 and the target wireless device 30, from the RSSI value notified from the reference wireless device 20. The estimated distance “dₑₛₜᵢₘₐₜₑ” can be obtained by the expression representing the path loss shown in Expression 2. More specifically, the RSSI value notified from each reference wireless device 20 is input into the following Expression 7 to calculate the estimated distance “dₑₛₜᵢₘₐₜₑ”.

RSSI=−10α log₁₀ dₑₛₜᵢₘₐₜₑ+β [Expression 7]

For instance, the distance estimator 16 inputs the each RSSI value notified from each of the reference wireless devices 20A to 20C into Expression 7 to calculate the estimated distance “dₑₛₜᵢₘₐₜₑ” for each of the reference wireless devices 20A to 20C.

(Step S106) The position estimator 17 calculates the position of the target wireless device 30. The position estimator 17 calculates the position where a likelihood function is the largest, as the position of the target wireless device 30, using the standard deviation of the distance obtained in step S104 and Expression 1.

Assuming that RSSI values measured by “n” reference wireless devices 20 are RSSI1, RSSI2, . . . , RSSIn and the positions of “n” reference wireless devices 20 are (x₁, y₁), (x₂, y₂), . . . , (xₙ, yₙ), the position (x, y) of the target wireless device 30 is represented by the following Expression 8. The “n” is an integer at least two. The “i” is an integer ranging from 1 to “n”.

$$\begin{matrix}( x , y ) = {arg max}_{( x , y )} P ( x , y \vert RSSI , … , RSSIn ) \\ = {arg max}_{( x , y )} {\prod }_{i}^{ } P ( x , y \vert RSSIi )\end{matrix} \qquad [ Expression 8 ]$$

where the distance “dᵢ” between the target wireless device 30 and the reference wireless device 20 at the position (xᵢ, yᵢ) can be represented by the following Expression 9.

dᵢ=\sqrt{(x−xᵢ)²+(y−yᵢ)²}. [Expression 9]

Expression 8 is input into Expression 1 to obtain the following Expression 10.

$$( x , y ) = {arg max}_{( x , y )} {\prod }_{i}^{ } \frac{1}{{σ}_{i} \sqrt{2 π}} exp ( - \frac{{( {d}_{i} - {d}_{estimate\_i} )}^{2}}{2 {σ}_{i}^{2}} ) , \qquad [ Expression 10 ]$$

where “σᵢ” is the standard deviation of the distance corresponding to the reference wireless device 20 at the position (xᵢ, yᵢ); the value calculated in step S104 is adopted therefor. The “dₑₛₜᵢₘₐₜₑ_{_{—}}ᵢ” is an estimated distance “dₑₛₜᵢₘₐₜₑ” corresponding to the reference wireless device 20 at a position (xᵢ, yᵢ); the value calculated in step S105 is used therefor.

Logarithms of both sides of Expression 10 are taken to obtain the following Expression 11.

$$( x , y ) = {arg max}_{( x , y )} ( {\sum }_{i}^{ } ( - \frac{{( {d}_{i} - {d}_{estimate\_i} )}^{2}}{2 {σ}_{i}^{2}} ) + {\sum }_{i}^{ } log \frac{1}{{σ}_{i} \sqrt{2 π}} ) . \qquad [ Expression 11 ]$$

The second term on the right side of Expression 11 is constant. Accordingly, the following Expression 12 is obtained.

$$( x , y ) = {arg min}_{( x , y )} {\sum }_{i}^{ } \frac{{( {d}_{i} - {d}_{estimate\_i} )}^{2}}{2 {σ}_{i}^{2}} \qquad [ Expression 12 ]$$

The position estimator 17 provides “σᵢ” and “dₑₛₜᵢₘₐₜₑ_{_{—}}ᵢ” in Expression 12, and calculates the position (x, y) of the target wireless device 30 using an optimization method, such as a steepest descent method, thereby obtaining the position of the target wireless device 30.

Thus, according to this embodiment, the standard deviation calculator 15 of the position estimating device 10 calculates the standard deviation of the distance for the probability distribution of the distance “d” between the wireless devices in Expression 1, on the basis of the RSSI values measured by the reference wireless devices 20. Setting of the standard deviation of the distance according to situations can accurately obtain the position of the target wireless device 30 and reduce the estimation error of the position.

In the embodiment, “σ(RSSI_{rep,j})” of the standard deviation of the distance and “RSSI_{rep,j}” are plotted on coordinates to derive the approximated curve. Alternatively, fitting may be made to an exponential function to obtain an exponential function for calculating the standard deviation of the distance. As represented in Expression 2, the RSSI value is a logarithmic function of the distance “d”. In other words, the distance “d” is an exponential function of the RSSI value. Accordingly, the standard deviation of the distance “d” can be represented as an exponential function of the RSSI value.

More specifically, the standard deviation “σ(RSSI_{rep,j})” of the distance and the “RSSI_{rep,j}” are fitted to an exponential function represented as the following Expression 13 to obtain optimum values of parameters “a” and “b”.

σ=a·e^{b-RSSI} [Expression 13]

The standard deviation calculator 15 can calculate the standard deviation of the distance by inputting the RSSI value notified from the reference wireless device 20 into the exponential function.

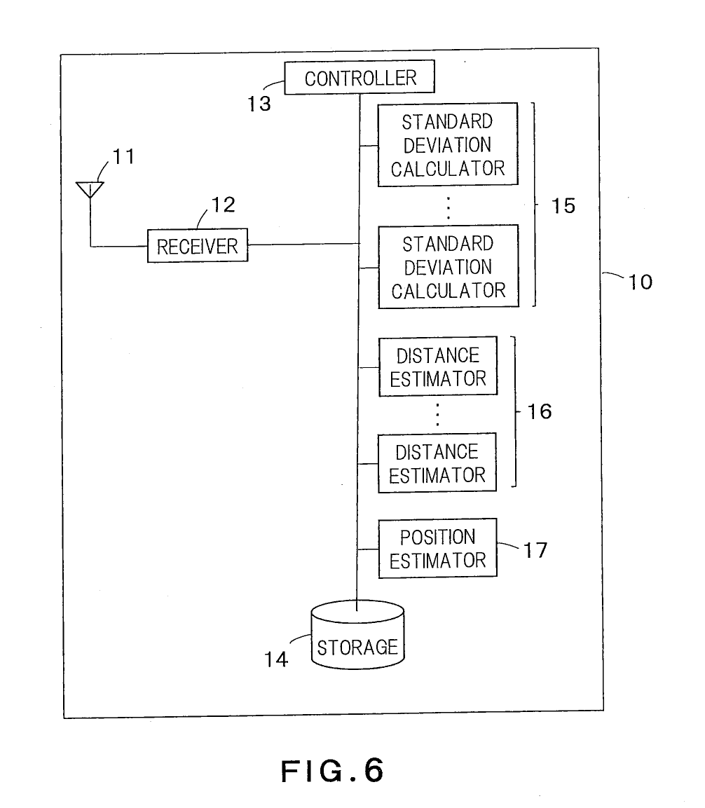

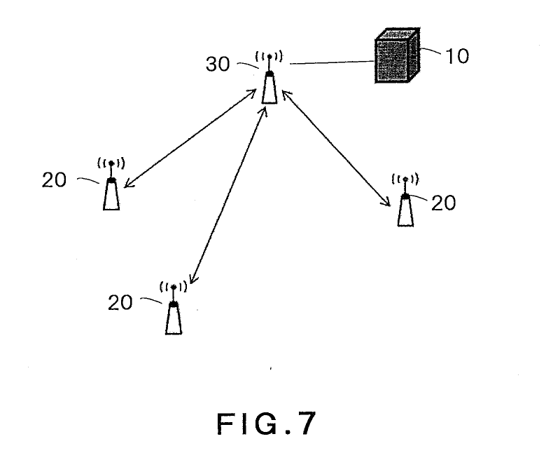

FIG. 6 shows a block configuration of a position estimating device 10 according to a variation. As shown in FIG. 6, standard deviation calculators 15 and the plurality of distance estimators 16 corresponding to reference wireless devices 20 may be provided to calculate the standard deviations “σ(RSSI)” of the distances and the estimated distances “dₑₛₜᵢₘₐₜₑ” between the wireless devices, in parallel, for corresponding reference wireless devices 20.

FIG. 1 shows the example where the three reference wireless devices 20A to 20C are provided in the wireless communication system. Alternatively, in order to estimate the position of the target wireless device 30 in a two-dimensional space, three or more reference wireless devices 20 at known positions are provided. In the case of estimating the position of the target wireless device 30 in a one-dimensional space, two or more reference wireless devices 20 are sufficient. In the case of estimating the position of the target wireless device 30 in a three-dimensional space, four or more reference wireless devices are provided.

In the embodiment, the signal transmitted from the target wireless device 30 is received by the reference wireless device 20 to measure the RSSI value. Alternatively, as shown in FIG. 7, the signal transmitted from the reference wireless device 20 may be received by the target wireless device 30 to measure the RSSI value. In this case, the reference wireless device 20 has the configuration as shown in FIG. 2. The target wireless device 30 has the configuration as shown in FIG. 3. The target wireless device 30 notifies the position estimating device 10 of the measured RSSI value. The position estimating device 30 can calculates the position of the target wireless device 30 according to a method analogous to that in the embodiment.

In the embodiment, the reference wireless device 20 is not necessarily fixed. Alternatively, the device may be movable only if the position is known.

The position estimating device 10 may be integrated with the reference wireless device 20 or the target wireless device 30.

In the embodiment, the example has been described where the storage 14 stores the expressions (the approximated curve and the exponential function) for calculating the standard deviation of the distance from the RSSI values notified from the reference wireless devices 20. Alternatively, the storage 14 may store a table representing the relationship between the RSSI value and the standard deviation of the distance. In this case, the standard deviation calculator 15 refers to the table stored in the storage 14, and obtains the standard deviation of the distance from the RSSI values notified from the reference wireless devices 20.

This embodiment is an example, a part or all of the position estimation device 10 according to this embodiment may be implemented as an integrated circuit such as an LSI (Large Scale Integration) or an IC (Integrated Circuit) chip set. Each function block of the position estimation device 10 may be differentially implemented as a processor. A part or all of the position estimation device 10 may be integrated into a processor. The integrated circuit is realized not only by an LSI, but also by a dedicated circuit or by a general-purpose processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A position estimating device that estimates a position of a target wireless device, comprising:
a storage that stores positions of a plurality of reference wireless devices;
a receiver which receives a received signal strength indicator value in signal transmission and reception between the target wireless device and each reference wireless device;
a calculator that calculates a standard deviation for a probability distribution of distances between the target wireless device and each reference wireless device, using the received signal strength indicator value;
a first estimator that calculates an estimated distance between the target wireless device and each reference wireless device, using the received signal strength indicator value; and
a second estimator that calculates the position of the target wireless device, using the standard deviation, the estimated distance, and the positions of the plurality of reference wireless devices.

2. The position estimating device according to claim 1,
wherein the storage stores a relationship between the received signal strength indicator value and the standard deviation, and
the calculator calculates the standard deviation corresponding to each reference wireless device from the notified received signal strength indicator value, and the relationship between the received signal strength indicator value and the standard deviation.

3. The position estimating device according to claim 2, wherein the relationship between the received signal strength indicator value and the standard deviation is an exponential function with an exponent of the received signal strength indicator value.

4. The position estimating device according to claim 1, wherein the receiver is notified of the received signal strength indicator value from the reference wireless device.

5. The position estimating device according to claim 1, wherein the receiver is notified of the received signal strength indicator value from the target wireless device.

6. The position estimating device according to claim 1, wherein, provided that the estimated distance between the target wireless device and the reference wireless device is “dₑₛₜᵢₘₐₜₑ”, the received signal strength indicator value in signal transmission and reception between the target wireless device and the reference wireless device is RSSI value, an attenuation factor is “α”, and the received signal strength indicator value for a distance between wireless devices of one meter is “β”, the first estimator calculates the estimated distance “dₑₛₜᵢₘₐₜₑ” using a following expression,
RSSI=−10α log₁₀ dₑₛₜᵢₘₐₜₑ+β.

7. The position estimating device according to claim 6, wherein, provided that the standard deviation calculated by the calculator is “σ(RSSI)”, a probability distribution “P(d|RSSI)” of a distance “d” between the target wireless device and the reference wireless device is represented by a following expression,
$$P ( d \vert RSSI ) = \frac{1}{σ ( RSSI ) \sqrt{2 π}} exp ( - \frac{{( d - {d}_{estimate} )}^{2}}{2 {\{ ( σ ( RSSI ) ) \}}^{2}} ) .$$

8. The position estimating device according to claim 7, wherein the second estimator regards a distance between the target wireless device and the i-th reference wireless device as “dᵢ” (“i” is an integer), provides, as “σᵢ” of a following expression, a standard deviation corresponding to the i-th reference wireless device calculated by the calculator, provides, as “dₑₛₜᵢₘₐₜₑ_{_{—}}ᵢ”, the estimated distance “dₑₛₜᵢₘₐₜₑ” corresponding to the i-th reference wireless device calculated by the first estimator, and calculates a position (x, y) of the target wireless device,
$$( x , y ) = {arg min}_{( x , y )} {\sum }_{i}^{ } \frac{{( {d}_{i} - {d}_{estimate\_i} )}^{2}}{2 {σ}_{i}^{2}} .$$

9. A position estimating method that estimates a position of a target wireless device communicating with a plurality of reference wireless devices at known positions, comprising:
obtaining a received signal strength indicator value in signal transmission and reception between the target wireless device and each reference wireless device;
calculating a standard deviation for a probability distribution of a distance between the target wireless device and each reference wireless device using the received signal strength indicator value;
calculating an estimated distance between the target wireless device and each reference wireless device using the received signal strength indicator value; and
calculating the position of the target wireless device using the standard deviation, the estimated distance, and the positions of the plurality of reference wireless devices.

10. A wireless communication system, comprising:
a plurality of reference wireless devices;
a target wireless device that communicates with the plurality of reference wireless devices; and
a position estimating device that comprises:
a storage that stores positions of the plurality of reference wireless devices;
a receiver which receives a received signal strength indicator value in signal transmission and reception between the target wireless device and each reference wireless device;
a calculator that calculates a standard deviation for a probability distribution of distances between the target wireless device and each reference wireless device using the received signal strength indicator value;
a first estimator that calculates an estimated distance between the target wireless device and each reference wireless device using the received signal strength indicator value; and
a second estimator that calculates the position of the target wireless device using the standard deviation, the estimated distance, and the positions of the plurality of reference wireless devices.

11. The wireless communication system according to claim 10,
wherein the storage stores a relationship between the received signal strength indicator value and the standard deviation, and
the calculator calculates the standard deviation corresponding to each reference wireless device from the notified received signal strength indicator value, and the relationship between the received signal strength indicator value and the standard deviation.

12. The wireless communication system according to claim 11, wherein the relationship between the received signal strength indicator value and the standard deviation is an exponential function with an exponent of the received signal strength indicator value.

13. The wireless communication system according to claim 10, wherein the receiver is notified of the received signal strength indicator value from the reference wireless device.

14. The wireless communication system according to claim 10, wherein the receiver is notified of the received signal strength indicator value from the target wireless device.

15. The wireless communication system according to claim 10, wherein, provided that the estimated distance between the target wireless device and the reference wireless device is “dₑₛₜᵢₘₐₜₑ”, the received signal strength indicator value in signal transmission and reception between the target wireless device and the reference wireless device is RSSI value, an attenuation factor is “α”, and the received signal strength indicator value for a distance between wireless devices of one meter is “β”, the first estimator calculates the estimated distance “dₑₛₜᵢₘₐₜₑ” using a following expression,
RSSI=−10α log₁₀ dₑₛₜᵢₘₐₜₑ+β.

16. The wireless communication system according to claim 15, wherein, provided that the standard deviation calculated by the calculator is “σ(RSSI)”, a probability distribution “P(d|RSSI)” of a distance “d” between the target wireless device and the reference wireless device is represented by a following expression,
$$P ( d \vert RSSI ) = \frac{1}{σ ( RSSI ) \sqrt{2 π}} exp ( - \frac{{( d - {d}_{estimate} )}^{2}}{2 {\{ ( σ ( RSSI ) ) \}}^{2}} ) .$$

17. The wireless communication system according to claim 16, wherein the second estimator regards a distance between the target wireless device and the i-th reference wireless device as “dᵢ” (“i” is an integer), provides, as “σᵢ” of a following expression, a standard deviation corresponding to the i-th reference wireless device calculated by the calculator, provides, as “dₑₛₜᵢₘₐₜₑ_{_{—}}ᵢ”, the estimated distance “dₑₛₜᵢₘₐₜₑ” corresponding to the i-th reference wireless device calculated by the first estimator, and calculates a position (x, y) of the target wireless device,
$$( x , y ) = {arg min}_{( x , y )} {\sum }_{i}^{ } \frac{{( {d}_{i} - {d}_{estimate\_i} )}^{2}}{2 {σ}_{i}^{2}} .$$
